(19) United States
(12) Patent Application Publication
(10) Pub. No.: US 2024/0246219 A1
(43) Pub. Date: Jul. 25, 2024

(54) SMART ACCESSORY STORAGE DEVICE

(71) Applicant: MILWAUKEE ELECTRIC TOOL CORPORATION, Brookfield, WI (US)

(72) Inventors: Luke J. Skinner, West Bend, WI (US); Timothy J. Radtke, Chicago, IL (US)

(21) Appl. No.: 18/415,205

(22) Filed: Jan. 17, 2024

Related U.S. Application Data
(60) Provisional application No. 63/498,415, filed on Apr. 26, 2023.
(60) Provisional application No. 63/480,531, filed on Jan. 19, 2023.

(51) Int. Cl. B25H 3/00; B25F 5/00

(52) U.S. Cl. CPC B25H 3/003; B25F 5/00

(57) ABSTRACT

Systems and methods for a smart accessory storage device for power tool accessories. An example accessory storage device includes a housing including an accessory slot for storing an accessory, a sensor configured to detect a presence of the accessory within the accessory slot, and a controller connected to the sensor. The controller is configured to determine, based on a signal from the sensor, whether the accessory is located within the accessory slot, determine, when the accessory is not located within the accessory slot, determine a set of parameters associated with the accessory, and transmit the set of parameters to an external device.

### RELATED APPLICATIONS

This application claims priority to, and the benefit of, U.S. Provisional Patent Application No. 63/498,415, filed Apr. 26, 2023, and U.S. Provisional Patent Application No. 63/480,531, filed Jan. 19, 2023, of which the entire contents of both are hereby incorporated by reference.

### SUMMARY

Embodiments described herein provide systems and methods for a smart accessory storage device for power tool accessories.

Accessory storage devices described herein include a housing including an accessory slot for storing an accessory, a sensor configured to detect a presence of the accessory within the accessory slot, and a controller connected to the sensor. The controller is configured to determine, based on a signal from the sensor, whether the accessory is located within the accessory slot, determine, in response to determining that the accessory is not located within the accessory slot, a set of one or more parameters associated with the accessory, and transmit the set of parameters to an external device.

In some aspects, the accessory is one selected from the group consisting of a crimping die, a hole saw, a threading die, and a drill bit.

In some aspects, the sensor is a pressure sensor configured to monitor a weight applied to the accessory slot.

In some aspects, the sensor is an inductive sensor configured to sense the presence of a metallic accessory.

In some aspects, the external device is a power tool including a motor, and the set of one or more parameters includes control parameters for driving the motor.

In some aspects, the controller is further configured to determine whether the external device is within communication range to the accessory storage device, transmit a first key to the external device, receive a second key from the external device, and store the first key and the second key in a memory of the accessory storage device.

In some aspects, the controller connected to a memory storing a log of accessory usage, and the controller is further configured to update, in response to the accessory being removed from the accessory slot, the log of accessory usage, and update, in response to the accessory being returned to the accessory slot, the log of accessory usage.

In some aspects, the external device is a mobile device including a display and the external device provides the set of one or more parameters via the display.

In some aspects, the accessory slot is configured to store a first accessory. The controller is configured to determine, where the accessory is located in the accessory slot, whether the accessory is the first accessory, and generate, where the accessory is not the first accessory, a notification that the accessory is not the first accessory.

Methods for monitoring accessories in an accessory storage device described herein include determining, based on a signal from a sensor, whether an accessory is located within the accessory slot, determining, in response to determining that the accessory is not located within the accessory slot, a set of one or more parameters associated with the accessory, and transmitting the set of one or more parameters to an external device. The sensor is configured to detect a presence of the accessory within the accessory slot.

In some aspects, the accessory is one selected from the group consisting of a crimping die, a hole saw, a threading die, and a drill bit.

In some aspects, the sensor is a pressure sensor, and the method further comprises monitoring, using the pressure sensor, a weight applied to the accessory slot.

In some aspects, the sensor is a camera, and the method further comprises capturing, using the camera, an image of the accessory slot.

In some aspects, the sensor is an inductive sensor, and the method further comprises sensing, with the inductive sensor, the presence of a metallic accessory in the accessory slot.

In some aspects, the external device is a power tool including a motor, and the set of one or more parameters includes control parameters for driving the motor.

In some aspects, the method further comprises updating, in response to the accessory being removed from the accessory slot, a log of accessory usage, and updating, in response to the accessory being returned to the accessory slot, the log of accessory usage.

Accessory storage devices described herein include a housing including a plurality of accessory slots for storing a plurality of accessories, a plurality of presence sensors, each presence sensor configured to detect a presence of an accessory within a respective accessory slot, and a controller connected to the plurality of presence sensors. The controller is configured to determine, based on signals from the plurality of presence sensors, whether each accessory of the plurality of accessories are located in the respective accessory slot, and transmit, in response to at least one accessory being removed from the respective accessory slot, a type of the at least one accessory to an external device.

In some aspects, the type of the accessory includes at least one of a size of the accessory and a material of the accessory.

In some aspects, each presence sensor is one selected from the group consisting of a pressure sensor, a weight sensor, an inductive sensor, an optical sensor, a magnetic sensor, a mechanical switch, and an imaging device.

In some aspects, the controller is connected to a memory storing a log of accessory usage, and the controller is further configured to update, in response to the at least one accessory being removed from the respective accessory slot, the log of accessory usage, and update, in response to the at least one accessory being returned to the respective accessory slot, the log of accessory usage.

In some aspects, the controller is further configured to determine whether the external device is within a communication range to the accessory storage device, transmit a first key to the external device, receive a second key from the external device, and store the first key and the second key in a memory of the accessory storage device.

Before any embodiments are explained in detail, it is to be understood that the embodiments are not limited in their application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiments, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

Other features and aspects will become apparent by consideration of the following detailed description and accompanying drawings.

### BRIEF DESCRIPTION OF THE DRAWINGS

FIG. 1 illustrates a power tool in accordance with embodiments described herein.

FIG. 2 illustrates a block diagram of a controller for the power tool of FIG. 1 in accordance with embodiments described herein.

FIG. 3 illustrates an accessory storage device in accordance with embodiments described herein.

FIG. 4 illustrates a block diagram of a controller for the accessory storage device of FIG. 3 in accordance with embodiments described herein.

FIG. 5 illustrates a block diagram of a wireless communication controller in accordance with embodiments described herein.

FIG. 6 illustrates a communication system for the power tool of FIG. 1 and the accessory storage device of FIG. 3 in accordance with embodiments described herein.

FIG. 7 illustrates a communication system including the power tool of FIG. 1 in communication with one or more accessory storage devices in accordance with embodiments described herein.

FIG. 8 illustrates a communication system for a plurality of accessory storage devices in accordance with embodiments described herein.

FIG. 9 illustrates a flow chart of a method for controlling the power tool of FIG. 1 in accordance with embodiments described herein.

FIG. 10 illustrates a flow chart of a method for connecting the power tool of FIG. 1 and the accessory storage device of FIG. 3 in accordance with embodiments described herein.

FIG. 11 illustrates a flow chart of a method for tracking accessories within the accessory storage device of FIG. 3 in accordance with embodiments described herein.

FIG. 12 illustrates a flow chart of a method for tracking accessories within the accessory storage device of FIG. 3 in accordance with embodiments described herein.

FIG. 13 illustrates a flow chart of a method for tracking accessories within the accessory storage device of FIG. 3 in accordance with embodiments described herein.

### DETAILED DESCRIPTION

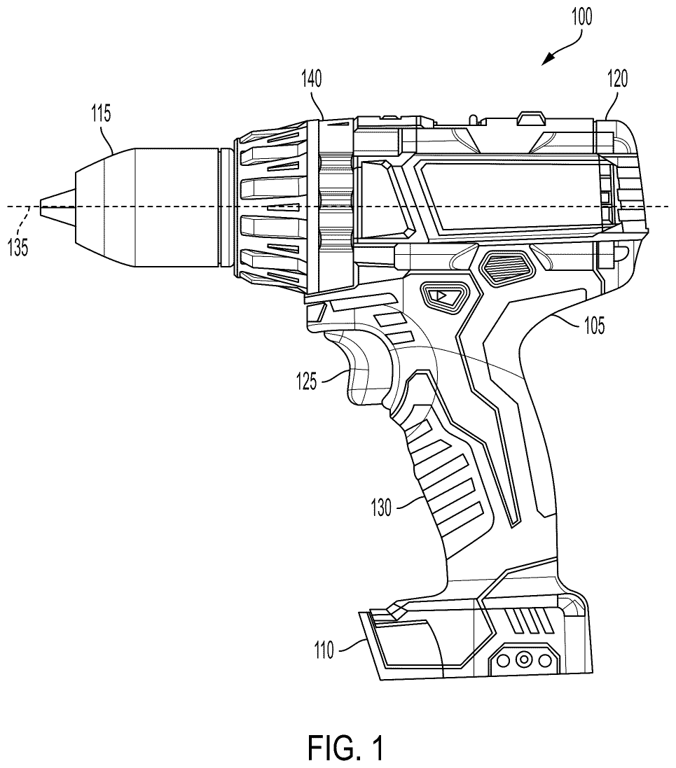

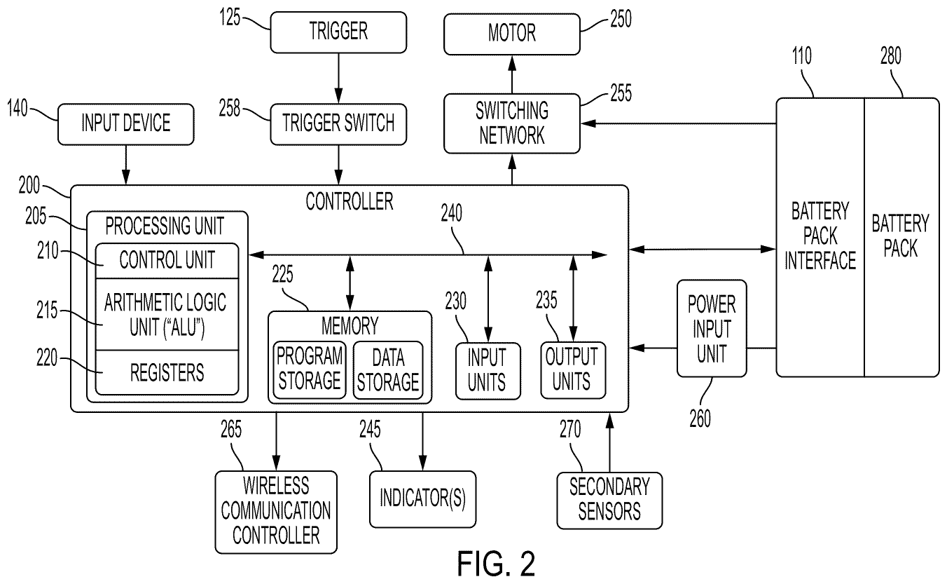

FIG. 1 illustrates an example power tool 100, according to some embodiments. The power tool 100 includes a housing 105, a battery pack interface 110, a driver 115 (e.g., a chuck or bit holder), a motor housing 120, a trigger 125, a handle 130, and an input device 140. The motor housing 120 houses a motor 250 (see FIG. 2). A longitudinal axis 135 extends from the driver 115 through a rear of the motor housing 120. The driver 115 is configured to receive, for example, a power tool accessory, such as a drill bit or a hole saw. During operation, the driver 115 rotates about the longitudinal axis 135. The longitudinal axis 135 may be approximately perpendicular with the handle 130. While FIG. 1 illustrates a specific power tool 100 with a rotational output, it is contemplated that the accessory storage devices described herein may be used with accessories for multiple types of power tools, such as drills, drivers, powered screw drivers, powered ratchets, grinders, right angle drills, rotary hammers, pipe threaders, or another type of power tool that experiences rotation about an axis (e.g., longitudinal axis 135). In some embodiments, the power tool 100 is a power tool that experiences translational movement along the longitudinal axis 135, such as reciprocal saws, chainsaws, pole-saws, circular saws, cut-off saws, die-grinder, crimpers, and table saws.

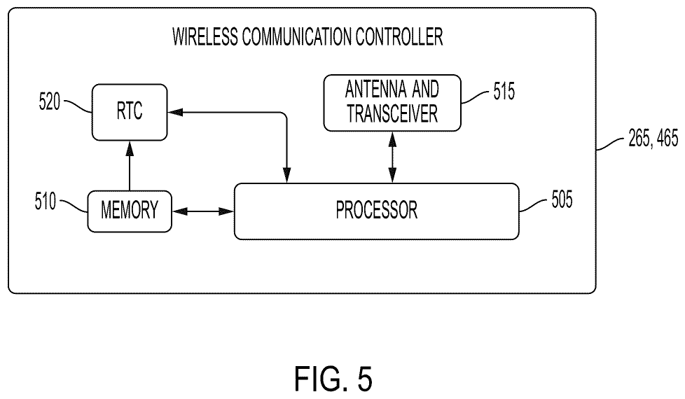

A power tool controller 200 for the power tool 100 is illustrated in FIG. 2. The power tool controller 200 is electrically and/or communicatively connected to a variety of modules or components of the power tool 100. For example, the illustrated power tool controller 200 is connected to indicators 245, secondary sensor(s) 270 (e.g., a current sensor, a voltage sensor, a temperature sensor, a speed sensor, etc.), the trigger 125 (via a trigger switch 258), a power switching network 255, a power input unit 260, and a tool wireless communication controller 265 (shown in more detail in FIG. 5).

The power tool controller 200 includes a plurality of electrical and electronic components that provide power, operational control, and protection to the components and modules within the power tool controller 200 and/or power tool 100. For example, the power tool controller 200 includes, among other things, a processing unit 205 (e.g., a microprocessor, an electronic processor, an electronic controller, a microcontroller, or another suitable programmable device), a memory 225, input units 230, and output units 235. The processing unit 205 includes, among other things, a control unit 210, an arithmetic logic unit (“ALU”) 215, and a plurality of registers 220 (shown as a group of registers in FIG. 2) and is implemented using a known computer architecture (e.g., a modified Harvard architecture, a von Neumann architecture, etc.). The processing unit 205, the memory 225, the input units 230, and the output units 235, as well as the various modules connected to the power tool controller 200 are connected by one or more control and/or data buses (e.g., common bus 240). The control and/or data buses are shown generally in FIG. 2 for illustrative purposes. The use of one or more control and/or data buses for the interconnection between and communication among the various modules and components would be known to a person skilled in the art in view of the embodiments described herein.

The memory 225 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 205 is connected to the memory 225 and executes software instructions that are capable of being stored in a RAM of the memory 225 (e.g., during execution), a ROM of the memory 225 (e.g., on a generally permanent basis), or another non-transitory computer readable medium such as another memory or a disc. Software included in the implementation of the power tool 100 can be stored in the memory 225 of the power tool controller 200. The software includes, for example, firmware, one or more applications, program data, filters, rules, one or more program modules, and other executable instructions. The power tool controller 200 is configured to retrieve from the memory 225 and execute, among other things, instructions related to the control processes and methods described herein. In other embodiments, the power tool controller 200 includes additional, fewer, or different components.

The power tool controller 200 drives the motor 250 to rotate the driver 115 in response to a user's actuation of the trigger 125. The driver 115 may be coupled to the motor 250 via an output shaft. Depression of the trigger 125 actuates a trigger switch 258, which outputs a signal to the power tool controller 200 to drive the motor 250, and therefore the driver 115. In some embodiments, the power tool controller 200 controls the power switching network 255 (e.g., a FET switching bridge) to drive the motor 250. For example, the power switching network 255 may include a plurality of high side switching elements (e.g., FETs) and a plurality of low side switching elements (e.g., FETs). The power tool controller 200 may control each switching element of the plurality of high side switching elements and the plurality of low side switching elements to drive each phase of the motor 250. For example, the power switching network 255 may be controlled to more quickly deaccelerate the motor 250.

The indicators 245 are also connected to the power tool controller 200 and receive control signals from the power tool controller 200 to turn on and off or otherwise convey information based on different states of the power tool 100. The indicators 245 include, for example, one or more light-emitting diodes (LEDs), a display screen, etc. The indicators 245 can be configured to display conditions of, or information associated with, the power tool 100. For example, the indicators 245 can display information relating to an operational state of the power tool 100, such as a mode or speed setting. The indicators 245 may also display information relating to a fault condition, or other abnormality of the power tool 100. In addition to or in place of visual indicators, the indicators 245 may also include a speaker or a tactile feedback mechanism to convey information to a user through audible or tactile outputs. In some embodiments, the indicators 245 display information relating to an accessory received by the power tool 100, such as a type of the accessory, the size of the accessory, and the like.

The battery pack interface 110 is connected to the power tool controller 200 and is configured to couple with a battery pack 280. The battery pack interface 110 includes a combination of mechanical (e.g., a battery pack receiving portion) and electrical components configured to and operable for interfacing (e.g., mechanically, electrically, and communicatively connecting) the power tool 100 with the battery pack 280. The battery pack interface 110 is coupled to the power input unit 260. The battery pack interface 110 transmits the power received from the battery pack 280 to the power input unit 260. The power input unit 260 includes active and/or passive components (e.g., voltage step-down controllers, voltage converters, rectifiers, filters, etc.) to regulate or control the power received through the battery pack interface 110 and to the power tool controller 200. In some embodiments, the battery pack interface 110 is also coupled to the power switching network 255. The operation of the power switching network 255, as controlled by the power tool controller 200, determines how power is supplied to the motor 250.

The input device 140 is operably coupled to the power tool controller 200 to, for example, select a forward mode of operation, a reverse mode of operation, a torque setting for the power tool 100, and/or a speed setting for the power tool 100 (e.g., using torque and/or speed switches), etc. In some embodiments, the input device 140 includes a combination of digital and analog input or output devices required to achieve a desired level of operation for the power tool 100, such as one or more knobs, one or more dials, one or more switches, one or more buttons, etc. In other embodiments, the input device 140 is configured as a dial or a ring (e.g., a torque ring). Movement of the input device 140 is configured to set a desired mode, torque, and/or speed value with which to drive the motor 250.

The secondary sensor(s) 270 may include current sensors, voltage sensors, speed sensors, temperature sensors, torque sensors, motion sensors, acceleration sensors, and the like, to detect additional conditions of the power tool 100.

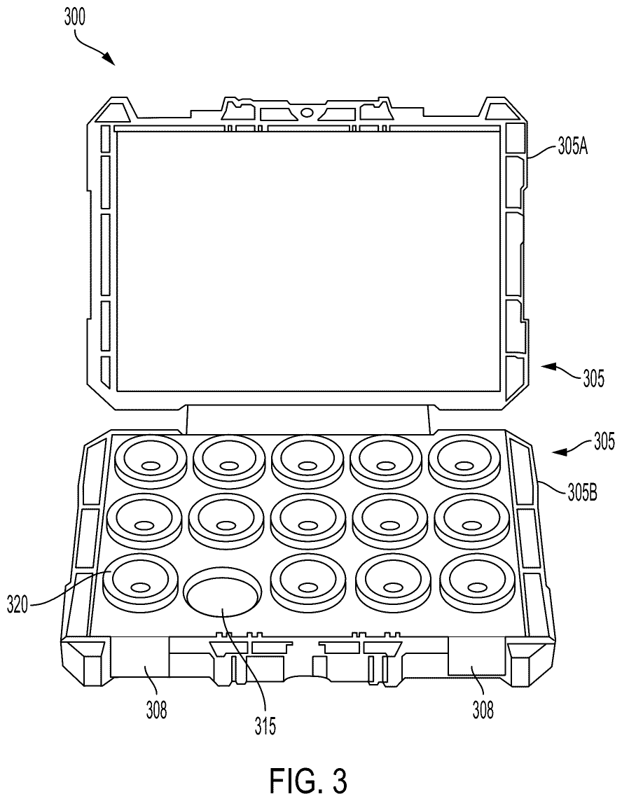

FIG. 3 illustrates an accessory storage device 300, according to some embodiments. the accessory storage device 300 includes an upper case 305A and a lower case 305B (referred to collectively as storage housing 305). A clamping device 308 may be provided to secure the upper case 305A and the lower case 305B together where the accessory storage device 300 is closed.

The accessory storage device 300 includes a plurality of accessory slots 315 for storing a plurality of accessories 320. In the example of FIG. 3, the plurality of accessories 320 are crimping dies. However, in other embodiments, the accessory storage device 300 may store other types of accessories, such as crimping jaws, U-style crimping dies, P-style crimping dies, W-style crimping dies, threading dies, hole saws, drill bits, saw blades, and other accessories driven by power tools. In embodiments where the accessories 320 are dies, the dies can be used for electrical applications (e.g., wire and couplings) or plumbing applications (e.g., pipe and couplings). The size of the dies depends on the size of a wire, pipe, coupling, etc., to be crimped. In some embodiments, die sizes include #8, #6, #4, #2, #1, 1/0, 2/0, 3/0, 4/0, 250 MCM, 300 MCM, 350 MCM, 400 MCM, 500 MCM, 600 MCM, 750 MCM, and 1000 MCM. The shape formed by the die can be circular or another shape. In some embodiments, the dies are configured to crimp various malleable materials and metals, such as copper (Cu) and aluminum (Al).

Accessories may be of different sizes and configured for operating on different materials. Accordingly, each accessory slot 315 may be configured to hold an accessory of a particular size or an accessory configured to perform a particular operation. For example, a first accessory slot 315 may be configured to store a 600 MCM copper crimping die, while a second accessory slot 315 may be configured to store a 750 MCM aluminum crimping die. A storage controller 400 may identify that the incorrect accessory is in an accessory slot 315.

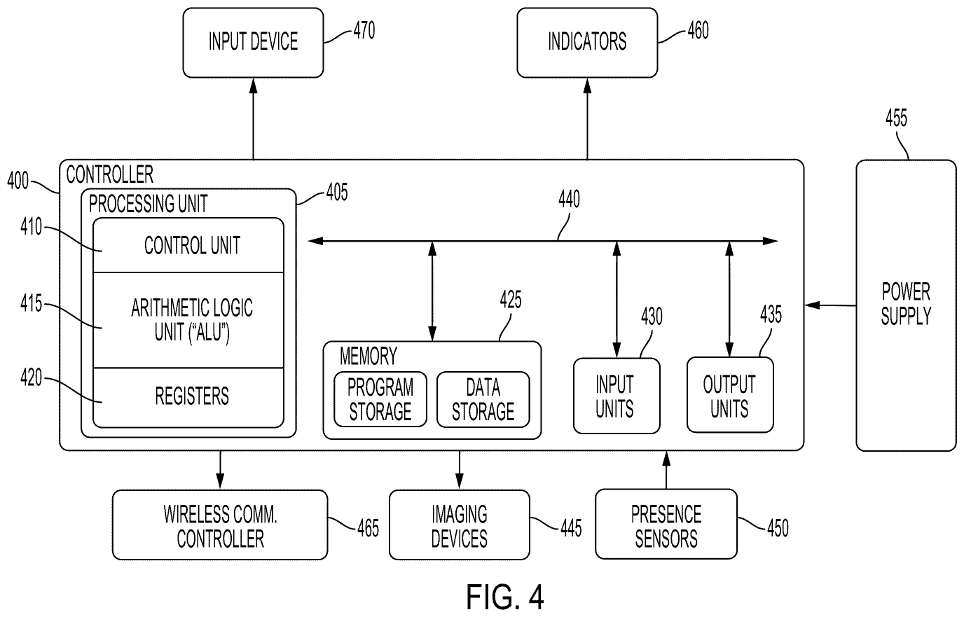

FIG. 4 illustrates a storage controller 400 for the accessory storage device 300. The storage controller 400 is electrically and/or communicatively connected to a variety of modules or components of the accessory storage device 300. For example, the illustrated storage controller 400 is connected to presence sensors 450, imaging devices 445, a power supply 455, indicators 460, an input device 470, and a storage wireless communication controller 465 (shown in more detail in FIG. 5).

The storage controller 400 includes a plurality of electrical and electronic components that provide power, operational control, and protection to the components and modules within the storage controller 400 and/or accessory storage device 300. For example, the storage controller 400 includes, among other things, a processing unit 405 (e.g., a microprocessor, an electronic processor, an electronic controller, a microcontroller, or another suitable programmable device), a memory 425, input unit 430, and output units 435. The processing unit 405 includes, among other things, a control unit 410, an arithmetic logic unit (“ALU”) 415, and a plurality of registers 420 (shown as a group of registers in FIG. 4) and is implemented using a known computer architecture (e.g., a modified Harvard architecture, a von Neumann architecture, etc.). The processing unit 405, the memory 425, the input units 430, and the output units 435, as well as the various modules connected to the storage controller 400 are connected by one or more control and/or data buses (e.g., common bus 440). The control and/or data buses are shown generally in FIG. 4 for illustrative purposes. The use of one or more control and/or data buses for the interconnection between and communication among the various modules and components would be known to a person skilled in the art in view of the embodiments described herein.

The memory 425 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 405 is connected to the memory 425 and executes software instructions that are capable of being stored in a RAM of the memory 425 (e.g., during execution), a ROM of the memory 425 (e.g., on a generally permanent basis), or another non-transitory computer readable medium such as another memory or a disc. Software included in the implementation of the accessory storage device 300 can be stored in the memory 425 of the storage controller 400. The software includes, for example, firmware, one or more applications, program data, filters, rules, one or more program modules, and other executable instructions. The storage controller 400 is configured to retrieve from the memory 425 and execute, among other things, instructions related to the control processes and methods described herein. In other embodiments, the storage controller 400 includes additional, fewer, or different components.

The power supply 455 is configured to provide power to the storage controller 400. The power supply 455 may be, for example, one or more insertable batteries, one or more rechargeable batteries, a battery pack, or the like. The input device 140 may be a button, switch, or other mechanical or electrical input that, in response to being actuated by a user, initiates a connecting or pairing process to connect or pair the accessory storage device 300 with another nearby accessory storage device 300, power tool 100, a remote device, etc. The indicators 460 are also connected to the storage controller 400 and receive control signals from the storage controller 400 to turn on and off or otherwise convey information based on different states of the accessory storage device 300. The indicators 460 include, for example, one or more light-emitting diodes (LEDs) or a display screen. The indicators 460 can be configured to display conditions of, or information associated with, the accessory storage device 300. For example, the indicators 460 can display information relating to the presence or absence of accessories 320 within the accessory storage device 300. In addition to or in place of visual indicators, the indicators 460 may also include a speaker to convey information to a user through audible or tactile outputs.

In some instances, the storage controller 400 detects the presence of accessories 320 within the accessory storage device 300 via the presence sensors 450 and/or the imaging devices 445. The presence sensors 450 may be electrical and/or mechanical sensors configured to detect whether an accessory 320 is situated within each accessory slot 315. For example, each accessory slot 315 may include a pressure sensor or weight sensor configured to detect a weight applied to the accessory slot 315 by an accessory 320 inserted within the accessory slot 315. In some embodiments, each accessory slot 315 includes an inductive sensor or a magnetic sensor configured to detect the presence of an accessory composed of a metal. In some embodiments, each accessory slot 315 includes a mechanical switch configured to be actuated in response to an accessory 320 being inserted within the accessory slot 315. In some embodiments, each accessory slot 315 includes an optical sensor configured to detect the presence of an accessory 320 within the accessory slot 315.

In some instances, imaging devices 445 are implemented to detect whether an accessory 320 is situated within each accessory slot 315. For example, a camera may be embedded within the lower case 305B and in proximity to each accessory slot 315 to capture an image of the accessory slot 315. In another example, a camera may be embedded within the upper case 305A and situated above each accessory slot 315 to capture an image of the accessory slot 315 in response to the accessory storage device 300 being closed.

In some instances, each accessory slot 315 is configured to store a particular accessory 320. Accordingly, the presence sensors 450 and/or the imaging devices 445 may provide signals to the storage controller 400 indicative of whether the correct accessory 320 is in the respective accessory slot 315. For example, where the presence sensor 450 is a weight sensor, the presence sensor 450 or controller 400 may be configured to detect whether an accessory 320 within an accessory slot has a particular, predetermined weight. In response to the accessory 320 not having the predetermined weight, the presence sensor 450 transmits a signal to the storage controller 400 indicating that the incorrect accessory 320 is situated within the accessory slot 315. In some embodiments, the controller 400 determines that the accessory 320 does not have the predetermined weight. In some embodiments, the storage controller 400 implements image processing software on images captured by the imaging devices 445. The image processing software may include a machine-learning algorithm configured to detect a type of accessory 320 situated within each accessory slot 315. The storage controller 400 may determine whether the correct accessory 320 is situated within each accessory slot 315 based on the results of the machine-learning algorithm. In some embodiments, the imaging devices 445 are configured to read or scan indicia on the accessory 320 that corresponds to the accessory 320 (e.g., a bar code, a QR code, a serial number, etc.), and the controller 400 is configured to identify the presence of the accessory 320 based on the indicia.

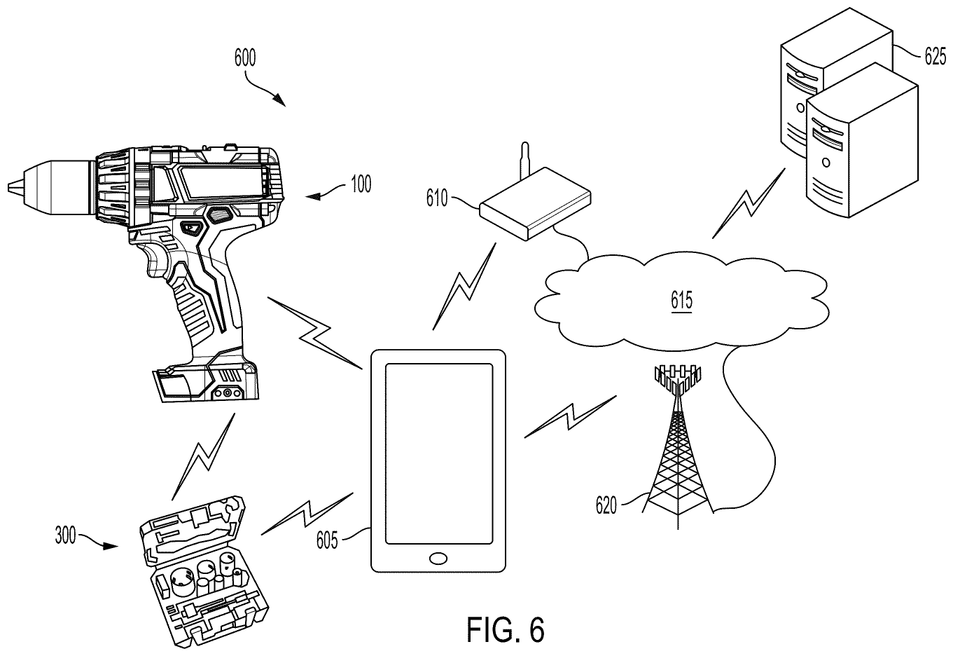

The power tool 100 includes the wireless communication controller 265 for communicating over a wireless communication network. Additionally, the accessory storage device 300 includes the wireless communication controller 465 for communicating over a wireless communication network. FIG. 5 illustrates an example wireless communication controller 265, 465. As shown in FIG. 5, the wireless communication controller 265, 465 includes a processor 505, a memory 510, an antenna and transceiver 515, and a real-time clock (RTC) 520. The wireless communication controller 265, 465 enables the power tool 100 and the accessory storage device 300 to communicate with a remote or external device 605 (see, e.g., FIG. 6). In some embodiments, the power tool 100 is considered an external device that communicates with the accessory storage device 300. The radio antenna and transceiver 515 operate together to send and receive wireless messages to and from the external device 605 and the processor 505. The memory 510 can store instructions to be implemented by the processor 505 and/or may store data related to communications between the power tool 100, the accessory storage device 300, and/or the external device 605. For example, the processor 505 associated with the wireless communication controller 265, 465 buffers incoming and/or outgoing data, communicates with the power tool controller 200 and storage controller 400, and determines the communication protocol and/or settings to use in wireless communications. The communication via the wireless communication controller 265, 465 can be encrypted to protect the data exchanged between the power tool 100, the accessory storage device 300, and the external device 605 from third parties.

In the illustrated embodiment, the wireless communication controller 265, 465 is a Bluetooth® controller. The Bluetooth® controller communicates with the external device 605 employing the Bluetooth® protocol. Therefore, in the illustrated embodiment, the external device 605, the power tool 100, and the accessory storage device 300 are within a communication range (i.e., in proximity) of each other while they exchange data. In other embodiments, the wireless communication controller 265, 465 communicates using other protocols (e.g., Wi-Fi, ZigBee, a proprietary protocol, etc.) over different types of wireless networks. For example, the wireless communication controller 265, 465 may be configured to communicate via Wi-Fi through a wide area network such as the Internet or a local area network, or to communicate through a piconet (e.g., using infrared or NFC communications).

In some embodiments, the network is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a 4G LTE network, 5G New Radio, a Digital Enhanced Cordless Telecommunications (“DECT”) network, a Digital AMPS (“IS-136/TDMA”) network, or an Integrated Digital Enhanced Network (“iDEN”) network, etc.

The wireless communication controller 265, 465 is configured to receive data from the power tool controller 200 and/or the accessory storage controller 400 and relay the information to the external device 605 via the antenna and transceiver 515. In a similar manner, the wireless communication controller 265, 465 is configured to receive information (e.g., configuration and programming information) from the external device 605 via the antenna and transceiver 515 and relay the information to the power tool controller 200 or the storage controller 400. In some embodiments, the power tool 100, the accessory storage device 300, and/or the external device 605 are additionally or alternatively configured to communicate with one another in a wired manner (e.g., using a USB cable, a USB-C cable, a serial communication connection, a parallel communication connection, etc.).

FIG. 6 illustrates a communication system 600. The communication system 600 includes at least one power tool 100, at least one accessory storage device 300, and the external device 605. Each power tool 100, each accessory storage device 300, and the external device 605 can communicate wirelessly while they are within a communication range of each other, or in a wired manner where the power tool 100, each accessory storage device 300, and the external device 605 are connected to one another by one or more wires or cables. Each power tool 100 may communicate power tool status, power tool operation statistics, power tool identification information, power tool sensor data, stored power tool usage information, power tool maintenance information, and the like. Each accessory storage device 300 may communicate accessory status, the presence or absence of each accessory 320 within each accessory slot 315, types of stored accessories, images captured by imaging devices 445, and the like.

The external device 605 is, for example, a mobile device, a smart phone (as illustrated), a laptop computer, a tablet computer, a personal digital assistant (PDA), or another electronic device capable of communicating wirelessly with the power tool 100 and the accessory storage device 300 and providing a user interface. The external device 605 provides the user interface and allows a user to access and interact with the power tool 100 and the accessory storage device 300. The external device 605 can receive user inputs to determine operational parameters, enable or disable features (such as a low-power operating mode), and the like. The user interface of the external device 605 provides an easy-to-use interface for the user to control and customize operation of the power tool 100. The external device 605, therefore, grants the user access to tool operational data of the power tool 100, and provides a user interface such that the user can interact with the power tool controller 200 of the power tool 100. Additionally, the user interface of the external device 605 provides an easy-to-use interface for the user to observe the status of the plurality of accessories 320 within the accessory storage device 300. For example, via the user interface, the user can observe which accessories 320 are present within the accessory storage device 300, which accessories 320 are removed from the accessory storage device 300, whether any accessories 320 are situated within the incorrect accessory slot 315, and the like.

In addition, as shown in FIG. 6, the external device 605 can also share the tool operational data obtained from the power tool 100 and accessory data obtained from the accessory storage device 300 with a remote server 625 connected through a network 615. The remote server 625 may be used to store the tool operational data obtained from the external device 605, provide additional functionality and services to the user, store accessory data obtained from the external device 605, or a combination thereof. In some embodiments, storing the information on the remote server 625 allows a user to access the information from a plurality of different locations. In some embodiments, the remote server 625 collects information from various users regarding their power tools 100 and their accessory storage device 300 and provide statistics or statistical measures to the user based on information obtained from the different power tools and accessories. For example, the remote server 625 may provide statistics regarding the experienced efficiency of the power tool 100, typical usage of the power tool 100, statistics regarding the usage of accessories 320 stored by the accessory storage device 300, and other relevant characteristics and/or measures of the power tool 100 and/or the accessory storage device 300. The network 615 may include various networking elements (routers 610, hubs, switches, cellular towers 620, wired connections, wireless connections, etc.) for connecting to, for example, the Internet, a cellular data network, a local network, or a combination thereof, as previously described. In some embodiments, the power tool 100 and/or the accessory storage device 300 is configured to communicate directly with the server 625 through an additional wireless interface or with the same wireless interface that the power tool 100 or accessory storage device 300 uses to communicate with the external device 605. In some embodiments, the external device 605 is configured to determine a location of the accessory storage device 300. For example, the external device 605 can use its location (e.g., using GPS location) as the location of the accessory storage device 300, which can then be communicated to the server 625 for tracking purposes.

As previously described, in some instances, the accessory storage device 300 communicates directly with the power tool 100. In some embodiments, the accessory storage device 300 and power tool 100 are capable of bi-directional communication. In such embodiments, the accessory storage device 300 may transmit accessory information to the power tool 100. The power tool 100 may transmit confirmation signals to the accessory storage device 300 confirming whether the accessory 320 indicated by the accessory storage device 300 is the accessory 320 received by the power tool 100. In some instances, the power tool 100 transmits operational data to the accessory storage device 300. In some embodiments, the accessory storage device 300 and the power tool 100 may communicate in a single direction. For example, the accessory storage device 300 may transmit accessory information to the power tool 100, but receive no information from the power tool 100, or vice versa.

In some embodiments, the power tool 100 and the accessory storage device 300 are connected (e.g., a Bluetooth connection) or paired (e.g., a Bluetooth pairing) prior to sharing operational and accessory information. For example, the power tool 100 and the accessory storage device 300 may share keys used to establish a link between the devices. The keys are used to, among other things, verify future reconnections and verify communicated data. Once the power tool 100 and the accessory storage device 300 are connected or paired, the power tool 100 and the accessory storage device 300 may automatically reconnect each time the power tool 100 is within communication range of the accessory storage device 300.

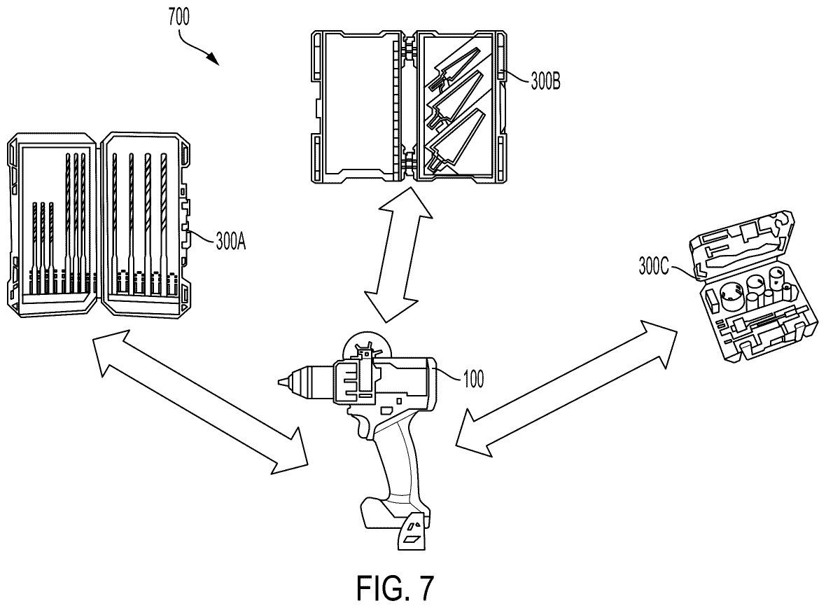

In some instances, the power tool 100 is connected to one or more (e.g., a plurality) of accessory storage devices 300. FIG. 7 provides an example communication system 700 including a plurality of accessory storage devices 300 communicatively connected to the power tool 100. In the example of FIG. 7, the plurality of accessory storage devices 300 include a first storage device 300A configured to store, for example, drill bits, a second storage device 300B configured to store, for example, step drill bits, and a third storage device 300C configured to store, for example, hole saws. In some embodiments, a fewer or greater number of accessory storage devices 300 may be provided. Additionally, in some embodiments, the plurality of accessory storage devices 300 may be configured to store different types of accessories. Each of the accessory storage devices 300 are configured to communicate removed and/or missing accessories to the power tool 100. For example, in response to a drill bit being removed from the first storage device 300A, the first storage device 300A transmits an indication of the type of the drill bit (e.g., a material the drill bit is composed of, a size of the drill bit, an identification of the drill bit, etc.) to the power tool 100. Similarly, where a step drill bit is removed from the second storage device 300B, the second storage device 300B transmits an indication of the type of the step drill bit to the power tool 100, and in response to a hole saw being removed from the third storage device 300C, the third storage device 300C transmits an indication of the type of the hole saw to the power tool 100.

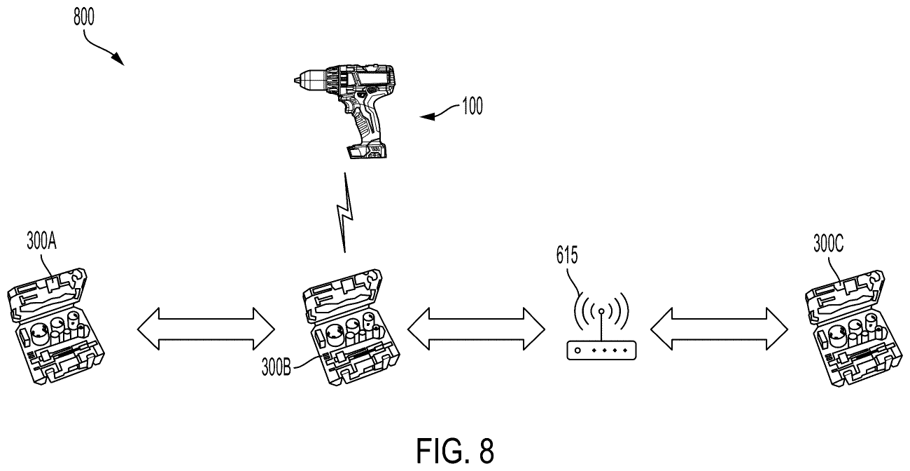

In some instances, the plurality of accessory storage devices 300 are configured to communicate with one another. FIG. 8 provides an example communication system 800 includes a plurality of accessory storage devices 300 communicatively connected to one another. Particularly, in the example of FIG. 8, the first storage device 300A is communicatively connected to the second storage device 300B such that the first storage device 300A and the second storage device 300B communicate information directly (e.g., short-distance communication). The second storage device 300B is communicatively connected to the third storage device 300C through a network 615 (e.g., long-distance communication).

In some embodiments, a subset of the plurality of accessory storage devices 300 are configured to communicate with the power tool 100. For example, as illustrated in FIG. 8, a power tool 100 may be communicatively connected to the second storage device 300B. The second storage device 300B receives accessory information from the first storage device 300A and the third storage device 300C, and provides the accessory information associated with the first storage device 300A and the third storage device 300C to the power tool 100 (e.g., the accessory storage devices can be daisy-chained together).

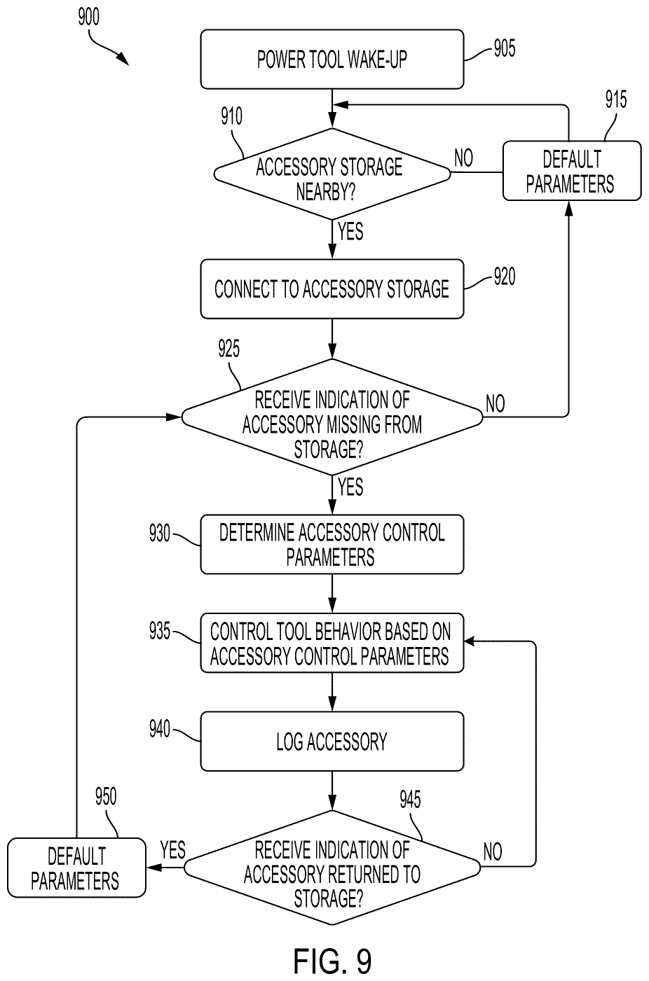

FIG. 9 illustrates a method 900 for operating the power tool 100. The method 900 may be performed by the power tool controller 200, or by the power tool controller 200 in communication with the storage controller 400. Various steps described herein with respect to the method 900 are capable of being executed simultaneously, in parallel, or in an order that differs from the illustrated serial and iterative manner of execution.

At block 905, the power tool controller 200 performs a power tool wake-up operation. For example, the power tool 100 may be turned on by a user. In some embodiments, the power tool 100 is moved to an active mode from an off or sleep mode (e.g., where the power tool 100 is picked up, upon the trigger 125 being activated, etc.). In response to determining that the power tool 100 is in the active mode, the power tool 100 may be configured to communicate with the accessory storage device 300.

At block 910, the power tool controller 200 determines whether a connected or paired accessory storage device 300 is near the power tool 100. For example, the power tool controller 200 determines whether a paired accessory storage device 300 is within a communication distance such that the power tool controller 200 and the accessory storage device 300 can communicate information to one another.

In response to determining that an accessory storage device 300 is not near the power tool 100 (“NO” at block 910), at block 915 the power tool controller 200 operates according to default parameters (e.g., a default mode). For example, default parameters for controlling the motor 250 may be stored within the memory 225. Where the power tool 100 is not communicatively connected to an accessory storage device 300, the power tool 100 operates according to the default parameters. In response to determining that an accessory storage device 300 is near the power tool 100 (“YES” at block 910), at block 920 the power tool controller 200 communicatively connects to the accessory storage device 300 such that the power tool 100 and the accessory storage device 300 may communicate information.

At block 925, the power tool controller 200 determines whether an indication of an accessory 320 missing from the accessory storage device 300 is received. For example, where an accessory 320 is removed from the accessory storage device 300, the accessory storage device 300 transmits a signal to the power tool 100. In some embodiments, the signal includes a type of the accessory 320 that was removed from the accessory storage device 300. In other embodiments, the signal includes accessory control parameters associated with the accessory 320 removed from the accessory storage device 300. In response to the power tool controller 200 determining that an indication of an accessory 320 missing from the accessory storage device 300 has not been received (“NO” at block 925), the power tool controller 200 proceeds to block 915 and operates according to default parameters.

In response to the power tool controller 200 determining an indication of an accessory 320 missing from the accessory storage device 300 has been received (“YES” at block 925), the power tool controller 200 proceeds to block 930 and determines accessory control parameters. For example, where the signal includes the type of the accessory 320, the power tool controller 200 compares the type of the accessory 320 to a table stored in the memory 225 to determine accessory control parameters. In some embodiments, the accessory control parameters are included in the indication from the accessory storage device 300.

At block 935, the power tool controller 200 controls the tool behavior based on the accessory control parameters. For example, the accessory control parameters (e.g., a set of one or more parameters) may include a maximum motor current, a minimum motor current, a maximum motor voltage, a minimum motor voltage, a maximum motor speed, a minimum motor speed, a soft start, and the like, for driving the motor 250. In some embodiments, the accessory control parameters include one or more functions for the power tool controller 200 to implement. For example, in embodiments where the power tool 100 is a crimping tool, the accessory control parameters may include a period of time at which to drive the motor 250 for the selected die, a pressure to achieve for the selected die, etc.

At block 940, the power tool controller 200 logs the received accessory 320. For example, the power tool controller 200 may maintain a historical log of accessories used by the power tool 100 within the memory 225. In some embodiments, the historical log is transmitted to the remote server 625 via the network 615. In other embodiments, the power tool controller 200 transmits an indication of the received accessory to the remote server 625 and/or accessory storage device 300. The remote server 625 then updates the historical log of accessories stored in the remote server 625.

At block 945, the power tool controller 200 determines whether an indication of the accessory 320 being returned to the accessory storage device 300 is received. In response to determining that the accessory 320 is not returned to the accessory storage device 300 (“NO” at block 945), the power tool controller 200 returns to block 935 and continues to control tool behavior based on the accessory control parameters associated with the accessory 320 received by the power tool 100. In response to determining that the accessory 320 is returned to the accessory storage device 300 (“YES” at block 945), the power tool controller 200 proceeds to block 950 and resets tool behavior to the default parameters or parameters associated with a different accessory 320. In some embodiments, while the power tool 100 is operating using the default parameters, the power tool controller 200 returns to block 925 and continues to monitor for indications of accessories from the accessory storage device 300.

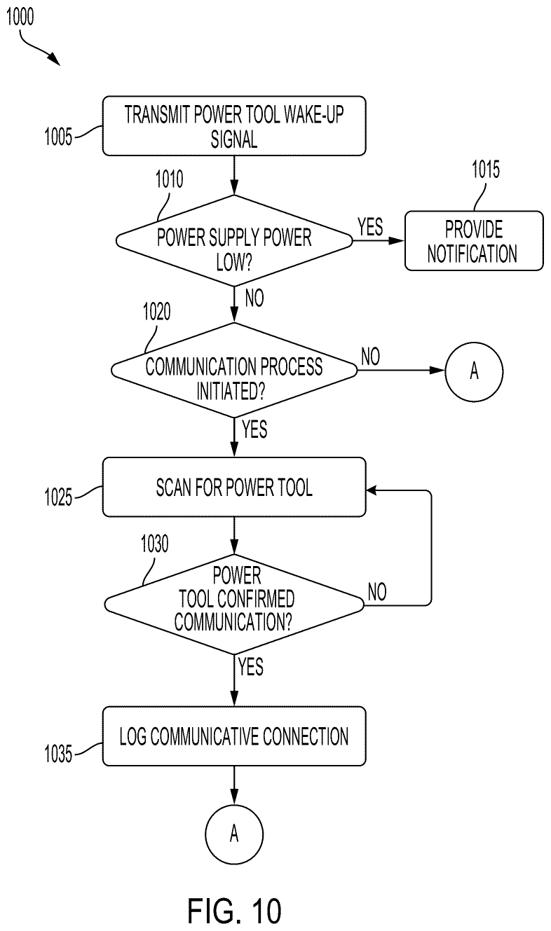

FIG. 10 provides a method 1000 for connecting or pairing the power tool 100 and the accessory storage device 300. The method 1000 may be performed by the storage controller 400, or by the storage controller 400 in combination with the power tool controller 200. Various steps described herein with respect to the method 1000 are capable of being executed simultaneously, in parallel, or in an order that differs from the illustrated serial and iterative manner of execution.

At block 1005, the storage controller 400 transmits a wake-up signal to the power tool 100. For example, storage controller 400 may transmit a wake-up signal to the power tool 100 to transition the power tool 100 from an off or sleep mode to an on or active mode. In some instances, the power tool 100 may be turned on by a user (e.g., picked up by the user, trigger 125 activated, etc.). While in the active mode, the power tool 100 may be configured to communicate with the accessory storage device 300.

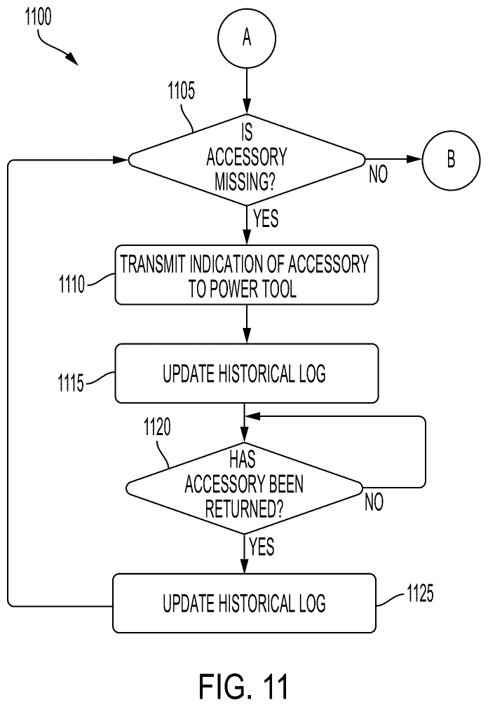

At block 1010, the storage controller 400 determines whether the power supply power is low. For example, the storage controller 400 may compare the voltage of the power supply to a threshold voltage. Where the voltage of the power supply is low (“YES” at block 1010), the storage controller 400 proceeds to block 1015 and provides a notification indicative of the power supply power being low via the indicators 460.

Where the voltage of the power supply is not low (“NO” at block 1010), the storage controller 400 proceeds to block 1020 and determines whether a communication process has been initiated (e.g., connecting, pairing, etc.). For example, the storage controller 400 may receive a signal from the input device 470 indicating the initiation of a pairing process. In response to determining that a communication process has not been initiated (“NO” at block 1020), the storage controller 400 proceeds to block 1105 (see FIG. 11). In response to determining that the communication process has been initiated (“YES” at block 1020), the storage controller 400 proceeds to block 1025 and scans for a nearby power tool 100. For example, the storage controller 400 may generate and broadcast a key to nearby power tools 100. At block 1030, the storage controller 400 determines whether a power tool 100 has confirmed the communicative connection. For example, a power tool 100 may transmit a key to the accessory storage device 300 in response to receiving the key from the accessory storage device 300. In the event the accessory storage device 300 does not receive a key and the communication is not confirmed (“NO” at block 1030), the accessory storage device 300 returns to block 1025 and continues to scan for a nearby power tool 100.

Upon, for example, receiving the key from the power tool 100, the storage controller 400 determines the communication is confirmed (“YES” at block 1030), and proceeds to block 1035 and logs the communicative connection. For example, the key received from the power tool 100 and the key generated by the accessory storage device 300 may be stored in the memory 425 such that the accessory storage device 300 can reconnect to the power tool 100 during future operations. In some embodiments, after logging the communicative connection, the storage controller 400 proceeds to block 1105 (see FIG. 11).

FIG. 11 provides a method 1100 for tracking the plurality of accessories 320 within the accessory storage device 300. The method 1100 may be performed by the storage controller 400, or by the storage controller 400 in combination with the power tool controller 200. Various steps described herein with respect to the method 1100 are capable of being executed simultaneously, in parallel, or in an order that differs from the illustrated serial and iterative manner of execution.

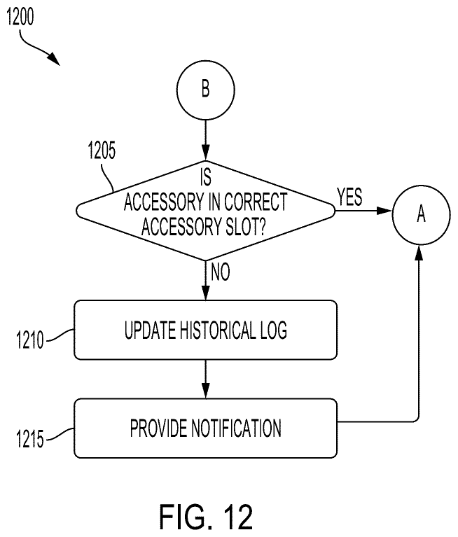

At block 1105, the storage controller 400 determines whether an accessory 320 is missing from the accessory storage device 300. For example, the storage controller 400 receives signals from the presence sensors 450 and/or the imaging devices 445 indicating the presence or absence of the accessories 320 in each of the accessory slots 315. In response to determining that an accessory 320 is not missing from its respective accessory slot 315 (“NO” at block 1105), or all accessories 320 are situated within an accessory slot 315, the storage controller 400 proceeds to block 1205 (see FIG. 12).

In response to determining that an accessory 320 is missing from its respective accessory slot 315 (“YES” at block 1105), the storage controller 400 proceeds to block 1110 and transmits an indication of the missing accessory 320 to the power tool 100. In some embodiments, the accessory storage device 300 transmits a type of the accessory 320 that is missing from the accessory storage device 300 to the power tool 100. In other embodiments, the accessory storage device 300 transmits accessory control parameters associated with the missing accessory 320 to the power tool 100. At block 1115, the storage controller 400 updates a historical log with an accessory ID. For example, where the accessory 320 is removed from the accessory storage device 300, the storage controller 400 updates a log of accessory usage stored by the memory 425 to indicate removal of the accessory 320. The accessory ID may indicate a type of the accessory 320.

At block 1120, the storage controller 400 determines whether the accessory 320 has been returned to the accessory storage device 300. In response to the accessory 320 being determined to not have been returned to the accessory storage device 300 (“NO” at block 1120), the storage controller 400 continues to monitor for the return of the accessory 320. In response to the accessory 320 being determined to be returned to the accessory storage device 300 (“YES” at block 1120), the storage controller 400 updates the historical log to indicate the return of the accessory 320 to its respective accessory slot 315 at process block 1125. After the storage controller 400 updates the historical log, the storage controller 400 returns to block 1105 and monitors for whether an accessory 320 is removed from the accessory storage device 300.

FIG. 12 provides a method 1200 for tracking the plurality of accessories 320 within the accessory slots 315. The method 1200 may be performed by the storage controller 400, or by the storage controller 400 in combination with the power tool controller 200. Various steps described herein with respect to the method 1200 are capable of being executed simultaneously, in parallel, or in an order that differs from the illustrated serial and iterative manner of execution.

At block 1205, the storage controller 400 determines whether each accessory 320 is situated in the correct accessory slot 315. For example, each accessory slot 315 is configured to store an accessory 320 having a particular accessory type (for example, a particular size, weight, material, etc.). The presence sensor 450 for each respective accessory slot 315 may be configured to the accessory 320 that the accessory slot 315 is configured for. For example, the presence sensor 450 may be a pressure sensor configured to detect a predetermined pressure (e.g., weight) provided by the accessory 320 onto the accessory slot 315. Where the pressure provided by the accessory 320 is not the predetermined pressure, the storage controller 400 may determine that the incorrect accessory 320 is placed within the accessory slot 315.

In response to determining that the accessory 320 is in the correct accessory slot 315 (“YES” at block 1205), the storage controller 400 proceeds to block 1105 (see FIG. 11). In response to determining that the accessory 320 is not in the correct accessory slot 315 (“NO” at block 1205), the storage controller 400 proceeds to block 1210 and updates the historical log to indicate that the accessory 320 situated in the accessory slot 315 is incorrect. At block 1215, the storage controller 400 provides a notification indicative of the accessory 320 situated in the accessory slot 315 being incorrect via the indicators 460, the remove device 605, etc.

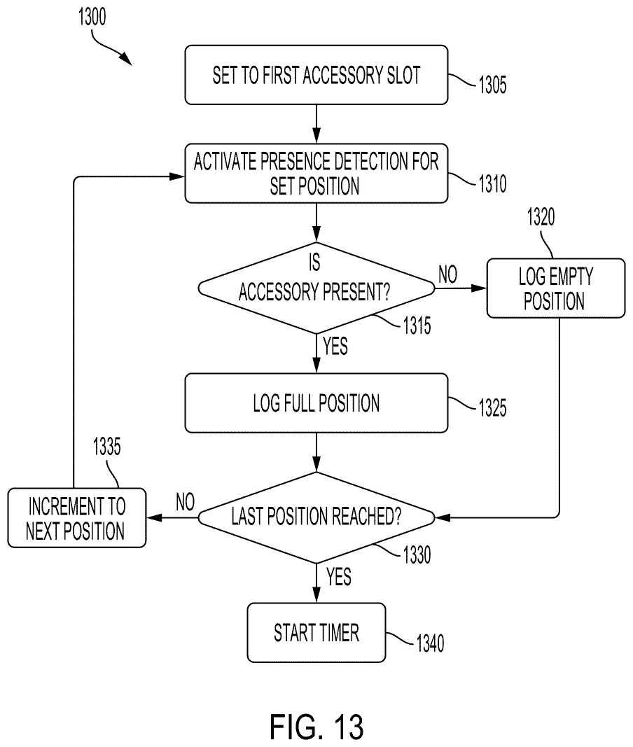

FIG. 13 provides a method 1300 for iteratively tracking the plurality of accessories 320 within each of the accessory slots 315. The method 1300 may be performed by the storage controller 400, or by the storage controller 400 in combination with the power tool controller 200. Various steps described herein with respect to the method 1300 are capable of being executed simultaneously, in parallel, or in an order that differs from the illustrated serial and iterative manner of execution.

At block 1305, the storage controller 400 sets the position to a first accessory slot of the plurality of accessory slots 315. At block 1310, the storage controller 400 activates presence detection for the set position. For example, the storage controller 400 receives a presence signal from the presence sensor 450 associated with the first accessory slot 315.

At block 1315, the storage controller 400 determines, based on the presence signal, whether an accessory 320 is situated in the set accessory slot. In response to determining that an accessory 320 is not situated in the set accessory slot (“NO” at block 1315), the storage controller 400 proceeds to block 1320 and logs an empty slot for the set position. In response to determining that an accessory 320 is situated in the set accessory slot (“YES” at block 1315), the storage controller 400 proceeds to block 1325 and logs a full slot for the set position. For example, the memory 425 may include a table indicating whether an accessory 320 is placed within each accessory slot 315. The storage controller 400 updates the table as accessories 320 are placed within the accessory storage device 300 and removed from the accessory storage device 300.

Regardless of whether the set accessory slot is empty or full, at block 1330, the storage controller 400 determines whether the last position is reached. For example, the storage controller 400 determines whether the presence or absence of an accessory 320 within each accessory slot 315 in the accessory storage device 300 has been logged. In response to determining that the last position is not reached (“NO” at block 1330), the storage controller 400 proceeds to block 1335 and increments the set position to the next position. For example, the storage controller 400 sets the position from the first accessory slot to a second accessory slot included in the plurality of accessory slots 315. In this manner, the storage controller 400 increments through each accessory slot 315. In response to determining that the last position is reached (“YES” at block 1330), the storage controller 400 proceeds to block 1340 and starts a timer. In some embodiments, in response to the timer being satisfied (e.g., reaches a threshold time value), the storage controller 400 returns to block 1305 and iteratively checks the status of the plurality of accessory slots 315. In other embodiments, in response to determining that the last position has been reached, the storage controller 400 immediately returns to block 1305. In some embodiments, the method 1300 is triggered by an accessory being removed from or placed within the accessory storage device 300.

Accordingly, the accessory storage device 300 provides for tracking of the location of accessories placed within and removed from the accessory storage device 300. Where an accessory 320 is removed from the accessory storage device 300, the accessory storage device 300 transmits an indication of the accessory 320 (e.g., a type of the accessory 320, a set of parameters associated with the accessory 320, or the like) to connected devices, such as to a power tool 100, an external device 605, remote server 625, or another accessory storage device 300. Additionally, the accessory storage device 300 monitors whether removed accessories 320 are returned and whether accessories 320 are placed within the correct accessory slot 315. Monitoring the movement of accessories 320 provides for management of the distribution and usage of accessories 320. Additionally, should an accessory 320 be missing from the accessory storage device 300 for a predetermined time period, the accessory storage device 300 may automatically order a restock of the missing accessory 320 (e.g., by way of communication with the external device 605).

Thus, embodiments provided herein describe, among other things, systems and methods for a smart accessory storage device. Various features and advantages are set forth in the following claims.

What is claimed is:

1. An accessory storage device comprising:
a housing including an accessory slot for storing an accessory;
a sensor configured to detect a presence of the accessory within the accessory slot; and
a controller connected to the sensor, the controller configured to:
determine, based on a signal from the sensor, whether the accessory is located within the accessory slot,
in response to determining that the accessory is not located within the accessory slot, determining a set of one or more parameters associated with the accessory, and
transmit the set of one or more parameters to an external device.

2. The accessory storage device of claim 1, wherein the accessory is one selected from a group consisting of a crimping die, a hole saw, a threading die, and a drill bit.

3. The accessory storage device of claim 1, wherein the sensor is a pressure sensor configured to monitor a weight applied to the accessory slot.

4. The accessory storage device of claim 1, wherein the sensor is a camera configured to capture an image of the accessory slot.

5. The accessory storage device of claim 1, wherein the sensor is an inductive sensor configured to sense the presence of a metallic accessory.

6. The accessory storage device of claim 1, wherein:
the external device is a power tool including a motor; and
the set of one or more parameters includes control parameters for driving the motor.

7. The accessory storage device of claim 1, wherein the controller is further configured to:
determine whether the external device is within communication range to the accessory storage device;
transmit a first key to the external device;
receive a second key from the external device; and
store the first key and the second key in a memory of the accessory storage device.

8. The accessory storage device of claim 1, wherein the controller is connected to a memory storing a log of accessory usage, and wherein the controller is further configured to:
update, in response to the accessory being removed from the accessory slot, the log of accessory usage; and
update, in response to the accessory being returned to the accessory slot, the log of accessory usage.

9. The accessory storage device of claim 1, wherein:
the external device is a mobile device including a display; and
the external device provides the set of one or more parameters via the display.

10. The accessory storage device of claim 1, wherein the accessory slot is configured to store a first accessory, and wherein the controller is configured to:
determine, in response to the accessory being located in the accessory slot, whether the accessory is the first accessory; and
generate, in response to determining that the accessory is not the first accessory, a notification that the accessory is not the first accessory.

11. A method for monitoring accessories in an accessory storage device, the method comprising:
determining, based on a signal from a sensor, whether an accessory is located within an accessory slot, the sensor configured to detect a presence of the accessory within the accessory slot;
in response to determining that the accessory is not located within the accessory slot, determining a set of one or more parameters associated with the accessory; and
transmitting the set of one or more parameters to an external device.

12. The method of claim 11, wherein the accessory is one selected from a group consisting of a crimping die, a hole saw, a threading die, and a drill bit.

13. The method of claim 11, wherein the sensor is a pressure sensor, the method further comprising:
monitoring, using the pressure sensor, a weight applied to the accessory slot.

14. The method of claim 11, wherein the sensor is a camera, the method further comprising:
capturing, using the camera, an image of the accessory slot.

15. The method of claim 11, wherein the sensor is an inductive sensor, the method further comprising:
sensing, with the inductive sensor, the presence of a metallic accessory in the accessory slot.

16. The method of claim 11, wherein:
the external device is a power tool including a motor; and
the set of one or more parameters includes control parameters for driving the motor.

17. The method of claim 11, further comprising:
updating, in response to the accessory being removed from the accessory slot, a log of accessory usage; and
updating, in response to the accessory being returned to the accessory slot, the log of accessory usage.

18. An accessory storage device comprising:
a housing including a plurality of accessory slots for storing a plurality of accessories;
a plurality of presence sensors, each presence sensor configured to detect a presence of an accessory within a respective accessory slot; and
a controller connected to the plurality of presence sensors, the controller configured to:
determine, based on signals from the plurality of presence sensors, whether each accessory of the plurality of accessories is located in the respective accessory slot, and
transmit, in response to at least one accessory being removed from the respective accessory slot, a type of the at least one accessory to an external device.

19. The accessory storage device of claim 18, wherein the type of the accessory includes at least one of a size of the accessory and a material of the accessory.

20. The accessory storage device of claim 18, wherein each presence sensor is one selected from a group consisting of a pressure sensor, a weight sensor, an inductive sensor, an optical sensor, a magnetic sensor, a mechanical switch, and an imaging device.
